(19) United States
(12) Patent Application Publication
(10) Pub. No.: US 2024/0228870 A1
(43) Pub. Date: Jul. 11, 2024

(54) DENSE PHOTOLUMINESCENT COMPOSITES AND PROCESSES FOR FABRICATING THE SAME

(71) Applicant: W. L. Gore & Associates, Inc., Newark, DE (US)

(72) Inventors: Mark D. Edmundson, Rancho Palos Verdes, CA (US); Gary P. Harp, Newark, DE (US); Michael B. Minor, Elkton, MD (US); Shaofeng Ran, Kennett Square, PA (US)

(21) Appl. No.: 18/562,963

(22) PCT Filed: May 24, 2022
(86) PCT No.: PCT/US2022/030703

§ 371 Date: Nov. 21, 2023

Related U.S. Application Data
(60) Provisional application No. 63/192,401, filed on May 24, 2021.

(51) Int. Cl. C09K 11/02; C08J 9/40; C09K 11/77; G01N 31/22; B82Y 20/00; B82Y 40/00

(52) U.S. Cl. CPC C09K 11/02; C08J 9/40; C09K 11/7774; G01N 31/22; B82Y 20/00; B82Y 40/00; C08J 2323/06; C08J 2327/18

(57) ABSTRACT

A dense photoluminescent composite comprises a dense membrane layer and luminophores. The photoluminescent composite is transparent and configured to modulate light transmitted through the composite. The composite may be made by filling an expanded, porous polymer with luminophores and/or densifying the polymer to form a dense membrane layer.

### CROSS-REFERENCE TO RELATED APPLICATION

This application is a national phase application of PCT Application No. PCT/US2022/030703, internationally filed on May 24, 2022, which claims the benefit of Provisional Application No. 63/192,401, filed May 24, 2022, which are incorporated herein by reference in their entireties for all purposes.

### FIELD

The present disclosure relates generally to dense photoluminescent composites. More specifically, the disclosure relates to photoluminescent composites including dense transparent polymeric film, and luminophores for modulating transmitted light and a method for manufacturing the same.

### BACKGROUND

Light modulation through the use of luminophores, such as quantum dots, phosphors, transition metal complexes, etc., has been a useful method for increasing the output of photovoltaics including sensors and solar cells by shifting the wavelength of incident sunlight. Additionally, light modulation can be used with both natural and artificial light systems, to shift the wavelength of transmitted light to reduce heat, photonically cool, alter color and/or alter the amount of UV radiation transmitted for a variety of applications.

### SUMMARY

Dense, photoluminescent composites according to the present disclosure comprise a dense membrane layer and a luminophore within and/or on the dense membrane layer. The photoluminescent composites are configured to modulate light transmitted through and/or within the composites.

According to an embodiment of the present disclosure, a method of making a dense composite film comprising luminophores, the method comprises providing a porous polymer membrane comprising a microporous matrix of nodes interconnected by fibrils and void space forming a plurality of pores characterized by an average pore size; providing a plurality of luminophores having an average particle size of less than 100 nm; filling at least a portion of the pores of the porous polymer membrane with the luminophores; and densifying the porous polymer membrane.

In a variation thereof, the porous polymer membrane is expanded polytetrafluoroethylene (ePTFE), expanded vinylidene fluoride (VDF) copolymer (eVDF), expanded poly (p-xylylene) (ePPX), expanded ultra-high molecular weight polyethylene (eUHMWPE), expanded ethylene tetrafluoroethylene (eETFE), and expanded polylactic acid (ePLLA). In another variation thereof, the filling step is conducted using vapor deposition or imbibing the pores with a liquid dispersion medium comprising the photoluminescent nanoparticles. In a further variation thereof, the method further comprises the step of drying the porous polymer membrane to remove the liquid dispersion medium before the densifying step. In another variation thereof, the liquid dispersion medium is at least one of aqueous and organic.

In a further variation thereof, the liquid dispersion medium comprises at least one dispersant. In another variation thereof, the porous polymer membrane is characterized by a length (x-axis), a width (y-axis), and a thickness (z-axis), wherein the thickness is from 0.1 μm to 250 μm. In another variation thereof, the porous polymer membrane comprises an asymmetric pore size throughout a thickness of the porous polymer membrane. In a further variation thereof, the luminophores in the densified composite film are distributed evenly through the z-axis. In another variation thereof, the luminophores in the densified composite film are not distributed evenly through the z-axis. In another variation thereof, the luminophores have an average particle size of less than 10 nm. In another variation thereof, the luminophores comprise at least one of quantum dots, atomic quantum clusters, gold nanoclusters, and perovskites. In a further variation thereof, the luminophores comprise at least one of lead sulfide, lead selenide, cadmium selenide, cadmium sulfide, cadmium telluride, indium arsenide, indium phosphide, cadmium selenide sulfide, and colloidal perovskite quantum dots. In another variation thereof, the method further comprises the step of stretching the densified composite film above the crystalline melt temperature. In another variation thereof, the method further comprises the step of sintering the porous polymer membrane at least partially. In further variation thereof, the sintering step occurs before the filling step. In a further variation thereof, the sintering step occurs after the densifying step. In another variation thereof, the dense composite film has a water vapor permeability coefficient of about 0.015 g-mm/m²/day or less.

According to another embodiment of the present disclosure, a photoluminescent dense film comprises a plurality of photoluminescent particles having an average particle size of less than 100 nm, the photoluminescent particles being immobilized within a densified polymer membrane having a microstructure of nodes interconnected by fibrils, the photoluminescent dense film comprises: a.) up to 40% wt. % of the photoluminescent particles based on the total weight of the photoluminescent dense film; b.) an average collimated transmittance of at least about 25%; and c.) an average haze coefficient of less than about 10% from 380 nm to 780 nm.

In a variation thereof, the average particle size is less than 10 nm. In another variation thereof, the film further comprises a detectable endotherm associated with the presence of residual fibrils. In another variation thereof, the densified polymer membrane is expanded polytetrafluoroethylene (ePTFE), expanded vinylidene fluoride (VDF) copolymer (eVDF), expanded polyparaxylylene (ePPX), expanded ultra-high molecular weight polyethylene (eUHMWPE), expanded ethylene tetrafluoroethylene (eETFE), and expanded polylactic acid (ePLLA). In another variation thereof, the densified polymer membrane comprises ePTFE and has a detectable endotherm between 375 C and 385 C that is associated with the presence of residual fibrils. In another variation thereof, the densified polymer membrane comprises expanded UHMWPE and has a detectable endotherm between 145 C and 155 C that is associated with the presence of residual fibrils. In another variation thereof, the photoluminescent particles comprise at least one of quantum dots, atomic oriented clusters, gold nanoclusters, and perovskites. In another variation thereof, a laminate comprises the photoluminescent dense film. In another variation thereof, an article comprises the photoluminescent dense film.

According to another embodiment of the present disclosure, a method of making a dense composite film comprising photoluminescent particles comprises providing a porous polymer membrane comprising a microporous matrix of nodes interconnected by fibrils and void space forming a plurality of pores characterized by an average pore size; providing a plurality of photoluminescent particles; filling at least a portion of the pores of the porous polymer membrane with the photoluminescent particles; and densifying the porous polymer membrane.

According to another embodiment of the present disclosure, a photoluminescent fluoropolymer dense film comprises a plurality of photoluminescent particles having an average particle size of less than 100 nm, the photoluminescent particles being immobilized within a dense fluoropolymer polymer film comprising: a.) 0.1 wt. % to 50 wt % of the photoluminescent particles based on the total weight of the photoluminescent dense film; b.) from 10 wt % to 99.9% of the fluoropolymer; c.) an average collimated transmittance at least about 25%; and d.) density of at least 1.8 g/cm3.

In a variation thereof, the fluoropolymer is substantially stable to UV light. In a variation thereof, the thickness of the film is from 0.1 μm to 250 μm. In a variation thereof, matrix tensile strength in the machine direction (MD) is at least 100 MPa. In a variation thereof, the matrix tensile strength in the transverse direction (orthogonal to the MD) is at least 100 MPa. In another variation thereof, the photoluminescent fluoropolymer dense film has a water vapor permeability coefficient of about 0.015 g-mm/m²/day or less.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a cross-section of a photoluminescent composite;

FIGS. 2 and 3 are cross-sections of photoluminescent composites with an uneven distribution of luminophores; and

FIG. 4 is a flowchart for a method of making a photoluminescent composite.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### Description of Various Embodiments

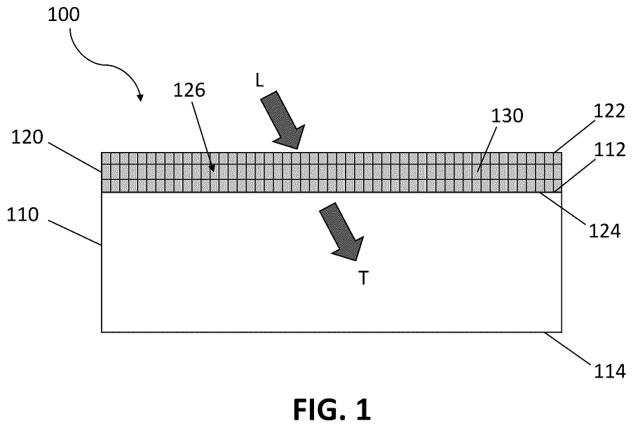

Referring first to FIG. 1, an exemplary embodiment of a photoluminescent composite 100 is shown. Photoluminescent composite 100 may also be referred to as a dense photoluminescent film or a dense film comprising luminophores. The photoluminescent composite 100 is transparent and configured to transmit incident light L through at least the dense membrane layer 120 of the photoluminescent composite 100 as transmitted light T. Optionally, the photoluminescent composite 100 is also configured to alter the wavelength and/or intensity of the transmitted light T. The illustrative photoluminescent composite 100 includes an optional substrate layer 110 (which may also be referred to as a support layer), a dense membrane layer 120, and a luminophore 130 on and/or in the dense membrane layer 120, each of which is described further below. Dense membrane layer 120 may also be referred to as a dense film layer, a dense layer, a dense film, a polymeric film, or a dense polymeric film.

The substrate layer 110 of the photoluminescent composite 100 may function substantially as a structural member to support and provide sufficient strength to the dense membrane layer 120 and to enable the photoluminescent composite 100 to function for its intended purpose in its intended operating environment or simply to enhance the transmittance of the composite 100. The substrate layer 110 may also provide protection to photoluminescent composite 100 from the environment or other external sources. For example, substrate layer 110 may act as a protective barrier for dense membrane layer 120. Substrate layer 110 may be on the top, bottom, and/or sides of dense membrane layer 120. The illustrative substrate layer 110 has a first, upper layer 112 coupled to the dense membrane layer 120 and a second, lower layer 114.

The substrate layer 110 may be constructed of a polymer, such as polytetrafluoroethylene (PTFE), fluorinated ethylene propylene (FEP), polyparaxylylene (PPX), perfluoroalkoxy copolymer resin (PFA), and polyolefins, including polypropylene and polyethylene. The substrate layer 110 may also be constructed of a metal, a fabric (e.g., woven fabric, non-woven fabric), wood, inorganics such as glass, cement, or another suitable material. In some embodiments, substrate layer 110 may comprise a surface of a structure or any physical system, such as a wall, floor, roof, rail, fence, etc. wherein the other layer or layers of composite 100 may be applied directly to the surface of the structure. The substrate layer 110 may be formed of a single material or multiple materials. The substrate layer 110 may be a single-layer structure or a multi-layer structure. The substrate layer 110 may be rigid or flexible. The substrate layer 110 may be uniform across a given direction or non-uniform across that direction. The substrate layer 110 may be flat as in a sheet or a slab as shown in FIG. 1, a roll, or any other desired shape, including curved surfaces and three-dimensional objects. The substrate layer 110 may be configured to maintain intimate contact or contacts with the dense membrane layer 120 such that the separation between the substrate layer 110 and the dense membrane layer 120 is less than the thickness of the dense membrane layer 120. In certain embodiments, the substrate layer 110 may be omitted if unnecessary to support the dense membrane layer 120.

Substrate layer 110 may also comprise a device or system configured to receive light, such as a solar panel or a sensor. As will be described in more detail herein, the luminophore(s) 130 within dense membrane layer 120 may modulate light that passes through the photoluminescent composite 100 such that the wavelength of incident light L may be different than the wavelength of transmitted light T that is transmitted through the dense membrane layer 120.

In embodiments where substrate layer 110 is clear or transparent, transmitted light T may pass through dense membrane layer 120 as well as substrate layer 110. In embodiments where substrate layer 110 is partially or completely opaque, at least of a portion of transmitted light T may be absorbed by substrate layer 110. Substrate layer 110 may also comprise holes, slits, or other openings to allow light to pass through substrate layer 110.

The dense membrane layer 120 of the photoluminescent composite 100 functions substantially as a transmitter of solar radiation or other incident light L such that light passes through dense membrane layer 120. The illustrative dense membrane layer 120 has a first, upper side 122 that faces the incident light L and a second, lower side 124 that faces the substrate layer 110 and transmitted light T. The incident light L may pass through photoluminescent composite 100 from any direction. For example, incident light L may pass through photoluminescent composite 100 in the direction of the plane of the composite (in plane), entering through one side and exiting through at least another side. Incident light L may enter photoluminescent composite 100 from any direction and may pass through any portion of photoluminescent composite 100. Incident light L may also travel substantially within photoluminescent composite 100. Light may be transmitted through or travel within dense membrane layer 120, modulated by luminophores 130, and at least partially absorbed by substrate layer 110.

The dense membrane layer 120 may be constructed of a polymer, such as polytetrafluoroethylene (PTFE), fluorinated ethylene propylene (FEP), poly paraxylylene (PPX), perfluoroalkoxy copolymer resin (PFA), vinylidene fluoride (VDF), VDF copolymers (VDF-co-TFE or TrFE), ethylene tetrafluoroethylene (ETFE), polylactic acid (PLA) and/or polyolefins and/or hydrocarbons, including polypropylene, polyethylene, and ultra-high molecular weight polyethylene (UHMWPE), as well as mixtures and copolymers thereof. The dense membrane layer 120 may be formed as a microporous layer comprising an expanded and/or fibrillated polymer, a gel, or a flash-spun polymer and then densified (i.e., rendered denser). In one embodiment, the fibrillated polymer is fibrillated PTFE made from PTFE fine powder particles that are non-melt processible (i.e. the melt flow viscosity is too high for melt extrusion and requires high shear blending and/or paste processing for form the fibrillated polymer matrix) (see Expanded PTFE Applications Handbook—Technology, Manufacturing and Applications, Ebnesajjad, Sina, (1997), Elsevier, Cambridge, MA).

As used herein, “PTFE” also includes homopolymer PTFE and modified PTFE resins having up to 1 wt % of one or more ethylenic comonomers including, but not limited to perfluoroalkyl ethylene (e.g. perfluorobutyl ethylene; U.S. Pat. No. 7,083,225 to Baille), hexafluoropropylene, perfluoroalkyl vinyl ether (C1-C8 alkyl; such as perfluoro methyl vinyl ether, perfluoro ethyl vinyl ether, perfluoro propyl vinyl ether, perfluoro octyl vinyl ether, etc.).

As used herein, the terms “fibrillating” or “fibrillatable: refers to the ability of the fibrillatable polymer to form a node and fibril microstructure or a microstructure substantially comprised of only fibrils when exposed by sufficient shearing. The mixing may be accomplished, for example, by wet or dry mixing, by dispersion, or by coagulation. Time and temperatures at which the mixing occurs varies with particle size, material used, and the amount of particles being mixed and are can be determined by those of skill in the art.

The densified polymer may be densified mechanically, with heat, with pressure, by imbibing the expanded polymer with a liquid or solution to fill pores within the expanded polymer, or any combination thereof. In some embodiments, the densifying process may include filling the pores with a polymeric material such as polymethylmethacrylate (PMMA). The expanded membranes may be densified by imbibing with a polymer with a refractive index close to that of the matrix of the expanded, microporous substrate (e.g., poly(methyl methacrylate) (PMMA) imbibed into ePTFE). The densification may occur sequentially (e.g. add photoluminescent particles then apply polymeric material to fill the remaining void volume) or simultaneously (e.g. where the photoluminescent particles are mixed with the polymeric material and then imbibed into the porous polymeric film) with the imbibing of the membrane with luminophores.

In some embodiments, the densification process may not result in substantial shrinkage (e.g. 10% or less) in the x-axis or y-axis of the imbibed membrane. In some embodiments, the microporous film is restrained along the x and y axis during the densification process. The densification process may result in shrinkage in the x-axis and/or the y-axis of less than 25%, less than 20%, less than 10%, less than 5%, less than 1%, or less than 0.5%.

In certain embodiments, the dense membrane layer 120 may be formed by first expanding the polymer to create an article (e.g., membrane, tube or tape) having a microporous microstructure comprising a plurality of nodes interconnected by fibrils (or substantially only fibrils) and a void volume that defines the micropores. The expanded microporous article can then be densified as described above. Fibrils may be detected within a membrane/film through an endotherm associated with the fibrils. Endotherms may be detected, for example, through differential scanning calorimetry (DSC). Specific examples of fibrillatable polymers include, but are not limited to ultrahigh molecular weight polyethylene (UHMWPE) (U.S. Pat. No. 10,577,468 to Sbriglia), polylactic acid (PLLA; U.S. Pat. No. 9,732,184 to Sbriglia), copolymers of vinylidene fluoride with tetrafluoroethylene or trifluoroethylene (e.g. VDF-co-(TFE or TrFE) polymers; U.S. Pat. No. 10,266,670 to Sbriglia), poly (ethylene tetrafluoroethylene) (ETFE; U.S. Pat. No. 9,932,429 to Sbriglia), polyparaxylxylene (PPX; U.S. Pat. Appl. Publ. No. 2016-0032069 to Sbriglia), and polytetrafluoroethylene (PTFE; U.S. Pat. No. 3,315,020 to Gore; U.S. Pat. No. 3,953,566 to Gore; U.S. Pat. No. 5,814,405 to Branca; U.S. Pat. No. 8,757,395 to Bacino; and U.S. Pat. No. 7,083,225 to Baille). The expanded polymer may then be densified as noted above. For example, the dense membrane layer 120 may include densified expanded PTFE (ePTFE), densified expanded UHMWPE (eUHMWPE), densified expanded vinylidene fluoride (VDF) copolymers (eVDF), densified expanded poly (p-xylylene) (ePPX), densified expanded ethylene tetrafluoroethylene (eETFE), and densified expanded polylactic acid (ePLLA), and combinations, copolymers, and emulsions thereof. The thickness, porosity, and other features of the dense membrane layer 120 may be optimized to enhance its optical properties. For example, the dense membrane layer 120 may have a porosity from ˜0% to 30%, more specifically 1% to 30%, more specifically from 1% to 20%, more specifically from 1% to 15%, more specifically from 1% to 10%, more specifically from 1% to 5%. In other embodiments, dense membrane layer 120 may have a porosity less than 1%.

Dense membrane layer 120 may be characterized by a length (x-axis), a width (y-axis), and a thickness (z-axis). The dense membrane layer 120 may have a thickness from 0.1 μm to 2000 μm, more specifically 1 μm to 1000 μm, more specifically from 1 μm to 750 μm, more specifically from 1 μm to 500 μm, more specifically from 1 μm to 250 μm, more specifically from 1 μm to 200 μm, more specifically from 5 μm to 200 μm, more specifically from 5 μm to 150 μm.

Dense membrane layer 120 may be characterized by a water vapor permeability coefficient, and may have a vapor permeability coefficient of less than 1 g-mm/m²/day, less than 0.9 g-mm/m²/day, less than 0.8 g-mm/m²/day, less than 0.7 g-mm/m²/day, less than 0.6 g-mm/m²/day, less than 0.5 g-mm/m²/day, less than 0.4 g-mm/m²/day, less than 0.3 g-mm/m²/day, less than 0.2 g-mm/m²/day, less than 0.1 g-mm/m²/day, less than 0.05 g-mm/m²/day, less than 0.04 g-mm/m²/day, less than 0.03 g-mm/m²/day, less than 0.02 g-mm/m²/day, or less than 0.01 g-mm/m²/day.

The luminophore 130 of the photoluminescent composite 100 is configured to absorb energy and then emit that energy as light. The luminophore 130 may also be configured to shift at least a portion of the incident light L, and therefore may be referred to as a wavelength shifting material. As used herein, shifting light may be considered to mean altering the wavelength of light, such as inputting a first wavelength and transmitting a second wavelength. In some embodiments, luminophore 130 may transmit a longer wavelength than the wavelength of the incident light L. The luminophore 130 may absorb the incident light L as soon as it contacts the photoluminescent composite 100 (i.e. before being transmitted through dense membrane layer 120) and/or after being transmitted through dense membrane layer 120. Embodiments of the luminophore 130 may also include multiple wavelength shifting layers (e.g. each shifting different spectrum components into the optimum spectrum radiation range). In use, the photoluminescent composite 100 may be part of an albedo absorbing system used with solar or photovoltaic (PV) cells or modules, with the luminophore 130 shifting portions of spectrum components of solar radiation to a radiation range at which the PV cell or module operates more efficiently (e.g., 400 nm-1100 wavelengths). In certain embodiments, the luminophore 130 may be configured to down-shift short wavelength infrared radiation (SWIR) (e.g. radiation having 1100 nm-2400 nm wavelengths) into the optimum spectrum radiation range for the PV cell or module. In other embodiments, the luminophore 130 may be configured to up-shift ultraviolet (UV) radiation (e.g. far ultraviolet (FUV) radiation having 100 nm-200 nm wavelengths, middle ultraviolet radiation (MUC) having 200 nm-300 nm wavelengths, and/or near ultraviolet radiation having 300 nm-400 nm wavelengths) into the optimum spectrum radiation range for the PV cell or module. The luminophore 130 can, for example up-shift wavelengths (e.g. from UV and blue portions of the spectrum) into the optimum spectrum radiation range.

Suitable luminophores 130 may include any material suitable for incorporation in/on the dense membrane layer 120. As used herein, luminophores may also be referred to as photoluminescent particles or photoluminescent materials. Such materials include materials that span the range of sizes from microparticles though nanoparticles to atomic or molecular entities. Luminophores may be substantially spherical, cylindrical, irregular, or any other suitable shape. In certain embodiments, the luminophores 130 may be nanoparticles having an average particle size of less than 100 nm, less than 80 nm, less than 60 nm, less than 40 nm, less than 20 nm, or less than 10 nm. Such nanoparticles may be sized for receipt within micropores 126 of the expanded polymer, both before and after densification. Certain embodiments of luminophores 130 as described herein include phosphors, fluorophores/molecular dyes, and quantum dots. As used herein, quantum dots may have an average particle size of less than 100 nm, more specifically less than 50 nm, more specifically less than 25 nm, more specifically less than 10 nm. Suitable luminophores 130 include phosphors including, but not limited to, cerium-doped yttrium aluminium garnet (CeYAG), zinc sulfide (ZnS), strontium aluminate, CdSe, CdS, CdTe, ZnSe, ZnTe, InN, InP, AlGaAs, InGaAs, CuS, Ag₂S, CulnSe₂, CulnS₂, In₂S₃S, GaP, InP, GaN, AlN, GaAs, PbS, PbSe, PbTe, CuCl, Cu₂S, Cu₂Se, Cu₂ZnSnS₄, Cu₂ZnSnSe₄, Cu₂ZnSnTe₄, CulnTe₂, Si, Ge, Y₂O₃, Y₂S₃, Y₂Se₃, NaYF₄, NaYS₂, LaF₃, YF₃, ZnO, TiO₂, La₂O₂S, Y₂O₂S, Gd₂O₂S, Zn₃N₂, Zn₃P₂, alloys thereof, heterostructures thereof, and any combination thereof as well as Europium or Doped Europium nanocluster and ligands, Zeolites incorporating nano or molecular composites of Silver or Europium in Nanoclusters, Atomic Quantum Clusters, gold nanoclusters, and typical phosphors or microphosphors found in the lighting industry as described in U.S. Pat. Nos. 7,112,921B2, 4,512,911A, and 6,255,670B1, and any combination thereof. Suitable luminophores 130 also include fluorophores including, but not limited to, pyranine and other fluorescent dyes. Suitable luminophores 130 also include quantum dots, such as indium phosphide (InP), lead sulfide (PbS), and/or lead selenide (PbSe) quantum dots. Other suitable luminophores 130 include, for example, gypsum, calcite, quartz, orthoclase muscovite, kalinite, and rare earth materials (e.g. rare earth doped glass), as well as other material compounds including these materials. In certain embodiments, structures or materials of the types disclosed in U.S. Pat. No. 8,779,964 to Kelsey et al. may be included with luminophore 130. Suitable luminophores 130 also include perovskites.

The luminophore 130 may be provided as a powder. In certain embodiments, the luminophore 130 may include particles of 1 μm to 100 μm, more specifically 10 μm to 50 μm in diameter, more specifically 20 μm to 40 μm in diameter. In other embodiments, the luminophore 130 may include particles of 1 nm to 999 nm in diameter. In other embodiments in which the luminophore 130 comprises quantum dots, the luminophore 130 may include particles of less than 1 nm to 10 nm in diameters, such as 2 nm to 10 nm in diameter.

The dense membrane layer 120 may be loaded with a desired amount of the luminophore 130. In certain embodiments, the dense membrane layer 120 may be loaded with the luminophore 130 at a geometric area concentration (i.e., mass per unit area) of 0.5 g/m² to 50 g/m², more specifically 2 g/m² to 20 g/m², more specifically 5 g/m² to 15 g/m².

The location and distribution of the luminophore 130 on and/or in the dense membrane layer 120 may vary. In general, the luminophore 130 may be present on any nodes, on any fibrils, and/or within micropores before densification of the dense membrane layer 120. The luminophore 130 may also be present on the upper side 122 and/or the lower side 124 of the dense membrane layer 120. Luminophore 130 may be present within dense membrane layer 120, and/or on a surface of dense membrane layer 120. Various examples will now be described with reference to FIGS. 1-3.

With reference to the photoluminescent composite 100 of FIG. 1, the luminophore 130 is present throughout substantially the entire dense membrane layer 120 (i.e., from the upper side 122 to the lower side 124 of the dense membrane layer 120). In this embodiment, the incident light L may strike the polymer of the dense membrane layer 120 and the luminophore 130 substantially simultaneously.

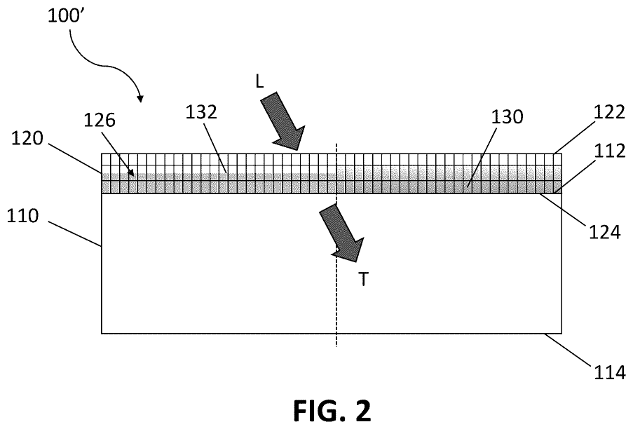

With reference to the photoluminescent composite 100′ of FIG. 2, the luminophore 130 is concentrated “inside” the photoluminescent composite 100′ near the lower side 124 of the dense membrane layer 120 and the optional substrate layer 110. As shown on the left side of FIG. 2, the luminophore 130 may have an abrupt boundary 132 beyond which the concentration of the luminophore 130 decreases toward the upper side 122 of the dense membrane layer 120. Alternatively, and as shown on the right side of FIG. 2, the luminophore 130 may gradually decrease in concentration toward the upper side 122 of the dense membrane layer 120. In this embodiment, the incident light L generally strikes the polymer of the dense membrane layer 120 before reaching the luminophore 130. Without wishing to be bound by theory the dense membrane layer 120 may help protect the luminophore 130 without exposing the luminophore 130 along the upper side 122.

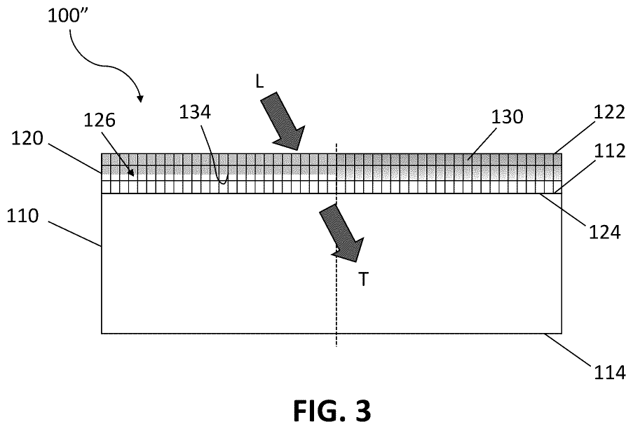

With reference to the photoluminescent composite 100″ of FIG. 3, the luminophore 130 is concentrated “outside” the photoluminescent composite 100″ near the upper side 122 of the dense membrane layer 120. As shown on the left side of FIG. 3, the luminophore 130 may have an abrupt boundary 134 beyond which the concentration of the luminophore 130 decreases toward the lower side 124 of the dense membrane layer 120. Alternatively, and as shown on the right side of FIG. 3, the luminophore 130 may gradually decrease in concentration toward the lower side 124 of the dense membrane layer 120. In this embodiment, the incident light L may strike the polymer of the dense membrane layer 120 and the luminophore 130 substantially simultaneously, similar to FIG. 1.

The photoluminescent composite 100, 100′, and/or 100″ may be characterized by a weight % of luminophores 130, a weight % of fibrillated polymer, a total luminous transmittance, an average haze coefficient, a reduced scattering coefficient, and/or at least one detectable endotherm.

The photoluminescent composite 100, 100′, 100″, may have a luminophore loading from 0.1 wt. % to 50 wt. %, more specifically from 1 wt. % to 50 wt. %, more specifically from 1 wt. % to 40 wt. %, more specifically from 1 wt. % to 35 wt. %, more specifically from 1 wt. % to 30 wt. %, more specifically from 1 wt. % to 25 wt. %, more specifically from 1 wt. % to 20 wt. %, more specifically from 1 wt. % to 15 wt. %, more specifically from 1 wt. % to 10 wt. %, more specifically from 1 wt. % to 5 wt. %.

The photoluminescent composite 100, 100′, 100″, may comprise a polymer in a loading from 50 wt. % to 99.9 wt. %, more specifically from 50 wt. % to 99 wt. %, more specifically from 60 wt. % to 99 wt. %, more specifically from 65 wt. % to 99 wt. %, more specifically from 70 wt. % to 99 wt. %, more specifically from 75 wt. % to 99 wt. %, more specifically from 80 wt. % to 99 wt. %, more specifically from 85 wt. % to 99 wt. %, more specifically from 90 wt. % to 99 wt. %, more specifically from 95 wt. % to 99 wt. %.

The average collimated transmittance composite 100, 100′, 100″, may be at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or at least 99.5% when corrected for Fresnel reflection.

The photoluminescent composite 100, 100′, 100″, may have an average haze coefficient from 360 nm to 780 nm of less than 75%, less than 70%, less than 65%, less than 60%, less than 55%, less than 50%, less than 45%, less than 40%, less than 30%, less than 25%, less than 20%, less than 15%, less than 10%, or less than 5%.

Photoluminescent composites 100, 100′, 100″ may have Photoluminescent Quantum Yield (PLQY) of at least 5%, at least 10%, at least 15%, at least 20%, at least 25%, at least 30%, at least 40%, at least 50%, at least 60%, at least 70%, at least 80%, or at least 90%.

Photoluminescent composites 100, 100′, 100″ may have a density of at least 0.75 g/cc, at least 1 g/cc, at least 1.25 g/cc, at least 1.5 g/cc, at least 1.75 g/cc, at least 2 g/cc, at least 2.25 g/cc, at least 2.5 g/cc, at least 2.75 g/cc, or at least 3 g/cc.

Photoluminescent composites 100, 100′, 100″ may have a matrix tensile strength in the machine direction (MD) and/or matrix tensile strength in the transverse direction (orthogonal to the MD) of is at least 25 MPa, at least 50 MPa, at least 75 MPa, at least 100 MPa, at least 125 MPa, at least 150 MPa, at least 175 MPa, or at least 200 MPa.

The photoluminescent composite 100, 100′, 100″ may have a detectable endotherm associated with the presence of residual fibrils from the expanded, porous membrane. The endotherm may be measured by, for example, differential scanning calorimetry. For example, the densified membrane layer 120 may comprise densified ePTFE and may comprise an endotherm between 375° C. and 385° C. associated with the presence of residual PTFE fibrils. In another example, the densified membrane layer 120 may comprise densified eUHMWPE and may have a detectable endotherm between 145° C. and 155° C. associated with the presence of residual UHMWPE fibrils.

The photoluminescent composite 100, 100′, 100″, may be used in laminates and articles to modulate light directed towards the laminates and articles.

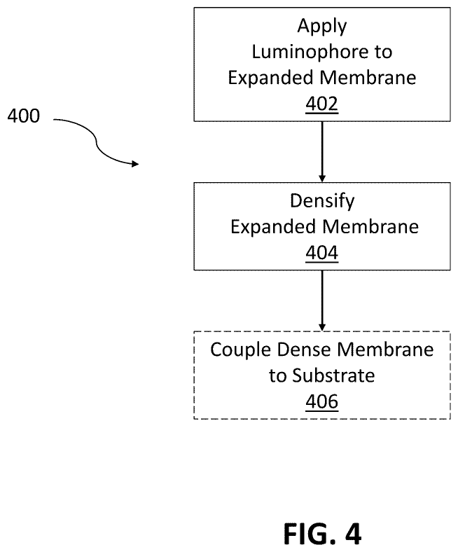

Referring now to FIG. 4, a diagram of a method 400 for assembling the photoluminescent composites 100, 100′, 100″ is shown. An expanded, porous polymer (or expanded porous membrane) and a luminophore 130 are provided at the start of method 400. At block 402, the luminophore 130 is applied to the expanded membrane layer. At block 404, the expanded membrane is densified to form dense membrane layer 120. At optional block 406, the dense membrane layer 120 is coupled to optional substrate layer 110.

The applying step of block 402, which may also be referred to as a filling or imbibing step, may involve spray coating, dip coating, painting, slot die, kiss coating, vapor deposition, vacuum pulling, or otherwise applying the luminophore 130. The luminophore 130 may be applied to one or both sides of an expanded membrane layer. In the “inside” embodiment of FIG. 2, for example, the luminophore 130 may be applied to the lower side 124 of the dense membrane layer 120 before the lower side 124 is coupled to the substrate layer 110. The luminophore 130 may be filled in the expanded, porous membrane by imbibing with a liquid dispersion medium comprising the luminophores 130. The liquid dispersion medium may comprise at least one of an aqueous organic solvent, and a dispersant.

The densifying step of block 404 comprises densifying the expanded membrane through at least one of heat, pressure, stretching, and imbibing. The densifying step collapses at least a portion of the open pores 126 within the expanded membrane by compressing the membrane and/or filling at least a portion of the pores 126 with the luminophores 130. For example, the expanded membrane may be heated to a temperature above the crystalline melt temperature of the expanded membrane and may be stretched to soften the fibrils and collapse at least a portion of the pores. In another example, the expanded membrane may be mechanically pressed to compress the membrane and collapse at least a portion of pores within the expanded membrane. The densifying step may be carried out as taught in U.S. Pat. No. 5,374,473 to Knox et al. and/or 7,521,010 to Kennedy et al. Densifying step 404 may occur simultaneously with applying step 402. For example, an expanded membrane may be imbibed with a polymeric material comprising luminophores to both imbibe and densify the membrane.

The coupling step of block 406 may involve coating, laminating, adhering, molding, friction welding, stitching, weaving, or otherwise coupling the dense membrane layer 120 to the optional substrate layer 110.

Method 400 may also comprise additional steps not shown, such as an optional step of stretching the dense membrane layer 120 above the crystalline melt temperature of the dense membrane layer 120. Method 400 may also comprise a sintering step, wherein the expanded membrane and/or the dense membrane layer 120 may be at least partially sintered. The sintering step may occur before the applying step, after the applying step, or after the densifying step.

The photoluminescent composites 100, 100′, 100″ (shown in FIGS. 1, 2, and 3 respectively) may be used in a variety of settings for transmitting and modulating incident light L. As noted above, the photoluminescent composites 100, 100′, 100″ may be used to transmit solar radiation and may be used in conjunction with PV cells or modules for collecting solar energy. Embodiments of composites may be configured to reduce or minimize reflection of solar radiation having wavelengths (e.g. spectrum portions) that can negatively impact the operation of the PV cell or module. For example, the PV conversion or other operational efficiency of certain solar modules can be reduced or degraded when operated at relatively high temperatures. Therefore, luminophore 130 may be configured to filter heat-inducing spectrum portions from the solar radiation received by the photoluminescent composites 100, 100′, 100″ and prevent the filtered spectrum portions from being transmitted to the PV cell or module. In some embodiments, the photoluminescent composites 100, 100′, 100″ can be configured to filter spectrum portions above 750 nm, above 1000 nm, above 1100 nm, or above 1200 nm.

Photoluminescent composites 100, 100′, 100″ may also be used within display screens, such as LCD displays. Photoluminescent composites 100, 100′, 100″ may be positioned on the surface of a display screen to alter the wavelength of light transmitted through the screen. Photoluminescent composites 100, 100′, 100″ may be positioned on the interior and/or the interior of a display screen.

The photoluminescent composites 100, 100′, 100″ may also be configured to enhance the amount of radiation reflected by altering the angular spread of the transmitted light T. Certain embodiments of photoluminescent composites 100, 100′, 100″ may also capture more global solar diffuse radiation over the course of a day and thereby enhance the amount of radiation directed towards a target surface. The photoluminescent composites 100, 100′, 100″ may be used as luminescent solar concentrators, configured to collimate, focus, and/or direct light to a target.

The photoluminescent composites 100, 100′, 100″ may also be used in artificial light settings, such as acting as transmitters for a light emitting diode (LED) module. For example, the photoluminescent composites 100, 100′, 100″ may be used in conjunction with an LED module to generally improve efficiency of the LED radiation for plant growth. The disclosed photoluminescent composites 100, 100′, 100″ or the luminophore 130 may be dispersed in or onto UV durable nanofibrillar structures. The nanofibrillar structures may be composed of fluoropolymers and perfluoropolymers, and polyolefins including, but not limited to, ePTFE.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

### TEST METHODS

It should be understood that although certain methods and equipment are described below, other methods or equipment determined suitable by one of ordinary skill in the art may be alternatively utilized.

### Thickness

Sample thickness of the porous membranes was measured using a non-contact method using a Keyence LS-7010M digital micrometer (Keyence Corporation, Mechelen, Belgium). The thickness of the dense composite films was measured using a contact method using a Mitutoyo Litematic VL-50A (Mitutoyo Corporation, Kawasaki, JP).

### Mass

Sample mass was measured using a laboratory analytical balance.

### Mass Per Area

The sample was cut to a well-defined geometric area (e.g., w=2.54 cm×l=15.24 cm) using a die or any precise cutting instrument. The mass per area was calculated by dividing the measured mass by the geometric area.

### Bulk Density

Bulk density was calculated by dividing the measured mass by the volume according to the following formula:

$$ρ = \frac{m}{w \cdot l \cdot t}$$

in which p is density (g/cm³), m is mass (g), w is width (cm), l is length (cm) and t is thickness (cm). The average of the three measurements was used.

### Airflow

The airflow through the membranes was measured using a gas flow measurement system ATEQ D520 gas flow leak tester version 1.00 (ATEQ, LES CLAYES SOUS BOIS, France). The ATEQ was attached to a sample fixture with pneumatically seals an O-ring to a 1.92 cm diameter circular area of a 2.9 cm on a support screen. Air flow is then recorded in L/hr at a differential pressure of 0.174 psi (12 millibar). Air flow measured this way can be converted to other common units of measurement using the relation 164.6467/(L/hr ATEQ Value)=Gurley Second Value and Gurley Second Value=3.126/Frazier number.

### Porosity

Porosity is (1-bulk density)/intrinsic density, then multiplying that value by 100. Intrinsic density can be measured using helium pycnometry or can be calculated as the volume weighted average of the intrinsic densities of the solid components. Approximate intrinsic density values of various components: PTFE (taken as 2.2 g/cm³), FEP (2.2 g/cm³), ETFE (1.7 g/cm³), PLA (1.25 g/cm³), PVDF (1.8 g/cm³), VDF-co-TFE (or TrFE) copolymers (˜1.95 g/cm³), UHMWPE (0.95 g/cm³), and PPX (varies by sub-type: Parylene C (1.289 g/cm³); Parylene N (1.10-1.12 g/cm³); Parylene F (1.652 g/cm³); Parylene D (1.418 g/cm³); and Parylene HT (1.320 g/cm³)).

### Tensile Break Load Measurements and Matrix Tensile Strength

Tensile break load was measured using an INSTRON 1122 tensile test machine equipped with flat-faced grips and a 0.445 kN load cell. The gauge length was 5.89 cm and the cross-head speed was 47.2 cm/min. The MTS was analyzed following the ASTM D412F dog bone method. For longitudinal MTS measurements, the larger dimension of the sample was oriented in the machine, or “down web, direction. For the transverse MTS measurements, the larger dimension of the sample was oriented perpendicular to the machine direction, also known as the cross web direction. Measurements were conducted at ambient pressure, relative humidity, and room temperature. Generally, this was 1 atmosphere, 25% relative humidity, and 21° C. The thickness and mass of each sample was measured as described above. The samples were then tested individually on the tensile tester. Three different sections of each sample were measured. The average of the three maximum load (i.e., the peak force) measurements was used. The longitudinal and transverse MTS were calculated using the following equation: MTS=(maximum load/initial cross-section area)*(intrinsic density of the respective sample)/bulk density of the sample). For example, the intrinsic density of PTFE is taken as 2.2 g/cm³

### Average Collimated Transmittance

A Jasco v-670 UV-Vis-NIR spectrophotometer with RSH-744 film sample holder was used to measure the transmittance spectra of film samples from a wavelength of 250 nm to 850 nm.

### Haze

To measure haze, the incident light (T₁), total light transmitted by the specimen (T₂), light scattered by the instrument (T₃), and light scattered by the instrument and specimen (T₄) were measured over a wavelength range of 250 to 2500 nm with a 1 nm step according to ASTM D1003-13 using a Jasco v-670 UV-Vis-NIR spectrophotometer equipped with a Jasco iln-725 integrating sphere (JASCO Corp., Tokyo, JP). Haze, % was calculated according to ASTM D1003-13.

### Photoluminescent Quantum Yield (PLQY)

A custom optical set-up was used to measure the quantum yield of film samples. The set-up consisted of an LED light source (M395F3 from Thorlabs Inc., Newton, MA) connected to an integrating sphere (IC2 Integrating Cube Stellarnet Inc., Tampa, FL) using fiber-optic cables. The light from the sphere was collected and the amount of light was measured in arbitrary units using a spectrophotometer (FIELDSPEC® 3 from Malvern Panalytical Ltd., Malvern, UK). First, a baseline was measured from a wavelength range of 350 nm to 2500 nm by placing a white reflectance standard on the reflectance sample port. Then, the film sample was measured from a wavelength range of 350 nm to 2500 nm by placing the sample on the reflectance sample port with the reflectance standard directly behind the sample, enabling most of the light that interacts with the sample to remain within the sphere to be collected by the spectrophotometer. Due to a lack of overlap between the wavelength range of the light source and the wavelength range of the emission spectra, the scatter peak and emission peak of the sample and blank were observed. The photoluminescent quantum yield was calculated by dividing the amount of emitted light by the amount of absorbed light using the equation:

$$PLQY = \frac{{E}_{B} - {E}_{A}}{{S}_{A} - {S}_{B}}$$

where:
S_{A} is the area under the curve of the scatter peak of the baseline,
S_{B} is the area of under the curve of the scatter peak of the sample,
E_{A} is the area under the curve of the emission peak of the baseline, and
E_{B} is the area under the curve of the emission peak of the sample.

### Examples

### Preparation of Examples 1-6

Examples 1-6 were each prepared by preparing an expanded, porous polymer membrane/film, imbibing with luminophores, and densifying the imbibed membrane. Each of the aforementioned steps are described in more detail herein.

Preparation of ePTFE Membrane A

An ePTFE membrane was manufactured according to the general teachings set forth in U.S. Pat. No. 3,953,566 to Gore. The membrane was not sintered. The ePTFE membrane had a mass-per-area of 6.3 g/m², a porosity of 92%, a non-contact thickness of 33.6 μm, an ATEQ air flow of 14.5 liters/cm²/hour at 12 mbar, a bubble point of 382.6 kPa, a matrix tensile strength of 165 MPa in the machine direction, a matrix tensile strength of 213 MPa in the transverse direction, a specific surface area of 21.682 m²/g, and a surface area per volume of 48.785 m²/cm³.

Preparation of ePTFE Membrane B

An ePTFE membrane was manufactured according to the general teachings set forth in U.S. Pat. No. 3,953,566 to Gore. The membrane was not sintered. The ePTFE membrane had a mass-per-area of 69 g/m², a porosity of 92%, a non-contact thickness of 371.9 μm, an ATEQ air flow of 0.9 liters/cm²/hour at 12 mbar, a bubble point of 506.1 kPa, a matrix tensile strength of 131 MPa in the machine direction, a matrix tensile strength of 110 MPa in the transverse direction, a specific surface area of 21.862 m²/g and a surface area per volume of 49.190 m²/cm³.

Preparation of ePTFE Membrane C

An ePTFE membrane was manufactured according to the general teachings set forth in U.S. Pat. No. 7,306,729. The ePTFE membrane had a mass-per-area of 4.8 g/m², a porosity of 85%, a non-contact thickness of 14.8 μm, an ATEQ air flow of 21.6 liters/cm²/hour at 12 mbar, a bubble point of 471 kPa.

Preparation of eUHMWPE Membrane A

An expanded polyethylene membrane (eUHMWPE) was manufactured according to the general teachings set forth in U.S. Pat. No. 9,926,416 to Sbriglia. The ePE membrane had a mass-per-area of 26.5 g/m², a porosity of 73%, a non-contact thickness of 91 μm, an ATEQ air flow of 1.5 liters/cm²/hour at 12 mbar, a bubble point of 341 kPa, a matrix tensile strength of 194.4 MPa in the machine direction, a matrix tensile strength of 137.2 MPa in the transverse direction, a specific surface area of 20.747 m²/g and a surface area per volume of 22.614 m²/cm³.

### Nanoparticle Imbibing Process

Each membrane was constrained onto a 6 in diameter hoop. Fluorescent nanoparticles (<100 nm; preferably 1 to 10 nm) dispersed in liquid were dispensed on the surface of the membrane towards one side of the hoop. A portion of the liquid wicked into the membrane. The remaining liquid was drawn across the surface of the membrane, resulting in a fully imbibed membrane. The excess liquid on the surface was wiped away with an absorbent wipe, and the membrane was dried in ambient conditions. The fluorescent nanoparticles remained within the microstructure of the membrane following drying, resulting in a fluorescent nanoparticle membrane composite. Membranes were imbibed with one of quantum dots, specifically CFQD® quantum dots in a liquid available from Nanoco Technologies Ltd., Manchester, UK.

### Y560 Phosphor Imbibing Process

A membrane was tensioned in a knitting hoop and placed on a 150 mm glass vacuum filter funnel (Sterlitech, Seattle WA, Part No. 20500023). 0.05 grams of a commercial yellow CeYAG phosphor (PhosphorTech, Kenesaw, GA, Y560) with nominal particle size of 30 μm as reported by the manufacturer was vortex mixed (VWR Vortex Mixer, Radnor, PA) in isopropyl alcohol and coated onto and into the membrane at 2.4 g/m² coverage using a vacuum filter flask. The hoop was removed from the flask assembly and allowed to air dry under convective airflow in a fume hood. The phosphor particles are too large to enter the microporous matrix, which was dried, then densified as previously described.

### Densifying Membranes

The expanded, imbibed membranes described above were then densified to form dense, photoluminescent composites. Examples 1, 4, and 6 were prepared by densifying imbibed ePTFE membrane B. Example 2 was prepared by densifying the imbibed eUHMWPE membrane A. Example 5 was prepared by densifying imbibed ePTFE membrane A. Each aforementioned fluorescent nanoparticle membrane composite was densified according to U.S. Pat. No. 5,374,473 to Knox et al. and/or U.S. Pat. No. 7,521,010 to Kennedy et al.

Example 3 was prepared by densifying imbibed ePTFE membrane C by imbibing with PMMA. A 10 wt % solution of PMMA (Sigma Aldrich, 182230-25G) in toluene was prepared by stirring at room temperature. A 3-mil drawdown bar was used to case a wet film of the poly methylmethacrylate (PMMA) solution on a polymer release liner (e.g., ETFE), and one of the hoop-restrained, quantum-dot-imbibed membranes described above was laid on top of the wet film so that the PMMA solution wicked up into the pores. The resulting sample was then dried, at which point it appeared transparent and was manually peeled off of the release liner.

Comparative Example 1—Non-Densified ePTFE with Quantum Dots

To prepare comparative example 1, the luminophore imbibing process was used on ePTFE membrane B, except the fluorescent nanoparticle membrane composite was not densified.

The composites as described above are characterized in tables 1 and 2 below.

TABLE 1
Characterization of Photoluminescent Composite Examples

| | | | | Dense | |
|---|---|---|---|---|---|
| | | Lumi- | Solution | Film | Composite |
| | | nescent | Concen- | Thick- | Bulk |
| | Expanded | Particle | tration | ness | Density |
| Example | Membrane | Type | (mg/mL) | (μm) | (g/cc) |
| 1 | ePTFE B | CFQD ® | 10 | 33.98 | 2.23 |
| | | Quantum | | | |
| | | Dots in | | | |
| | | Toluene | | | |
| 2 | eUHMWPE A | CFQD ® | 10 | 26.36 | 1.10 |
| | | Quantum | | | |
| | | Dots in | | | |
| | | Toluene | | | |
| 3 | ePTFE C | CFQD ® | 10 | 7.14 | 1.28 |
| | | Quantum | | | |
| | | Dots in | | | |
| | | Toluene | | | |
| 4 | ePTFE B | CFQD ® | 20 | 35.37 | 2.31 |
| | | Quantum | | | |
| | | Dots in | | | |
| | | Toluene | | | |
| 5 | ePTFE A | CFQD ® | 10 | 3.67 | 2.35 |
| | | Quantum | | | |
| | | Dots in | | | |
| | | Toluene | | | |
| 6 | ePTFE B | Y560 | 3 | 36.68 | 2.22 |
| | | Phosphor | | | |

TABLE 2
Characterization of Comparative Examples

| | | | Solution | | Composite |
|---|---|---|---|---|---|
| | | | Concen- | Thick- | Bulk |
| | Expanded | Luminescent | tration | ness | Density |
| Example | Membrane | Particle Type | (mg/mL) | (μm) | (g/cc) |
| Comp. 1 | ePTFE B | CFQD ® | 10 | (porous) | (porous) |
| | | Quantum | | | |
| | | Dots in | | | |
| | | Toluene | | | |

### Optical Analysis of Photoluminescent Composites

For this example, optical properties of the membranes prepared above were analyzed. The average collimated transmittance from 360 nm to 780 nm, haze from 360 nm to 780 nm, and photoluminescent quantum yield (PLQY) were measured for each composite, and the results are summarized in Table 3 below. It should be noted that comparative example 1 showed very little absorption.

TABLE 3
Optical Characterization

| | Avg. Collimated | Avg. | Photoluminescent |
|---|---|---|---|
| | Transmittance | Haze | Quantum Yield |
| Example | (%) | (%) | (%) |
| 1 | 32.7 | 55.4 | 60.7 |
| 2 | 28.5 | 64.0 | 51.6 |
| 3 | 75.5 | 15.6 | 28.0 |
| 4 | 26.6 | 62.8 | 27.6 |
| 5 | 60.7 | 28.9 | 7.7 |
| 6 | 33.7 | 55.8 | 62.3 |
| Comp. 1 | 0.00 | 99.3 | 69.9 |

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A method of making a dense composite film comprising luminophores, the method comprising:
providing a porous polymer membrane comprising a microporous matrix of nodes interconnected by fibrils and void space forming a plurality of pores characterized by an average pore size;
providing a plurality of luminophores having an average particle size of less than 100 nm;
filling at least a portion of the pores of the porous polymer membrane with the luminophores; and
densifying the porous polymer membrane.

2. The method of claim 1, wherein the porous polymer membrane is expanded polytetrafluoroethylene (ePTFE), expanded vinylidene fluoride (VDF) copolymer (eVDF), expanded poly (p-xylylene) (ePPX), expanded ultra-high molecular weight polyethylene (eUHMWPE), expanded ethylene tetrafluoroethylene (eETFE), and expanded polylactic acid (ePLLA).

3. The method of claim 1, wherein the filling step is conducted using vapor deposition or imbibing the pores with a liquid dispersion medium comprising the photoluminescent nanoparticles.

4. The method of claim 1, further comprising the step of drying the porous polymer membrane to remove the liquid dispersion medium before the densifying step.

5. The method of claim 3, wherein the liquid dispersion medium is at least one of aqueous and organic, or wherein the liquid dispersion medium comprises at least one dispersant.

6. (canceled)

7. The method of claim 1, wherein the porous polymer membrane is characterized by a length (x-axis), a width (y-axis), and a thickness (z-axis), wherein the thickness is from 0.1 μm to 250 μm.

8. The method of claim 7, wherein the porous polymer membrane comprises an asymmetric pore size throughout a thickness of the porous polymer membrane.

9. The method of claim 7, wherein the luminophores in the densified composite film are distributed evenly through the z-axis, or wherein the luminophores in the densified composite film are not distributed evenly through the z-axis.

10.-11. (canceled)

12. The method of claim 1, wherein the luminophores comprise at least one of quantum dots, atomic quantum clusters, gold nanoclusters, and perovskites.

13. The method of claim 12, wherein the luminophores comprise at least one of lead sulfide, lead selenide, cadmium selenide, cadmium sulfide, cadmium telluride, indium arsenide, indium phosphide, cadmium selenide sulfide, and colloidal perovskite quantum dots.

14. The method of claim 1, further comprising the step of stretching the densified composite film above the crystalline melt temperature.

15. The method of claim 1, further comprising the step of sintering the porous polymer membrane at least partially.

16. The method of claim 15, wherein the sintering step occurs before the filling step, or wherein the sintering step occurs after the densifying step.

17. (canceled)

18. The method of claim 1, wherein the dense composite film has a water vapor permeability coefficient of about 0.015 g-mm/m2/day or less.

19. A photoluminescent dense film comprising a plurality of photoluminescent particles having an average particle size of less than 100 nm, the photoluminescent particles being immobilized within a densified polymer membrane having a microstructure of nodes interconnected by fibrils, the photoluminescent dense film comprising:
a.) up to 40% wt. % of the photoluminescent particles based on the total weight of the photoluminescent dense film;
b.) an average collimated transmittance of at least about 25%; and
c.) an average haze coefficient of less than about 10% from 380 nm to 780 nm.

20. (canceled)

21. The photoluminescent dense film of claim 19, further comprising a detectable endotherm associated with the presence of residual fibrils.

22. The photoluminescent dense film of claim 19, wherein the densified polymer membrane is expanded polytetrafluoroethylene (ePTFE), expanded vinylidene fluoride (VDF) copolymer (eVDF), expanded polyparaxylylene (ePPX), expanded ultra-high molecular weight polyethylene (eUHMWPE), expanded ethylene tetrafluoroethylene (eETFE), and expanded polylactic acid (ePLLA), or wherein the densified polymer membrane comprises ePTFE and has a detectable endotherm between 375 C and 385 C that is associated with the presence of residual fibrils, or wherein the densified polymer membrane comprises expanded UHMWPE and has a detectable endotherm between 145 C and 155 C that is associated with the presence of residual fibrils.

23.-24. (canceled)

25. The photoluminescent dense film of claim 19, wherein the photoluminescent particles comprise at least one of quantum dots, atomic oriented clusters, gold nanoclusters, and perovskites.

26. A laminate or an article comprising the photoluminescent dense film of claim 19.

27. (canceled)

28. A method of making a dense composite film comprising photoluminescent particles, the method comprising:
providing a porous polymer membrane comprising a microporous matrix of nodes interconnected by fibrils and void space forming a plurality of pores characterized by an average pore size;
providing a plurality of photoluminescent particles;
filling at least a portion of the pores of the porous polymer membrane with the photoluminescent particles; and
densifying the porous polymer membrane.

29.-35. (canceled)
